(19) United States
(12) Patent Application Publication
(10) Pub. No.: US 2006/0212741 A1
(43) Pub. Date: Sep. 21, 2006

(54) Implementing a test regime for a network based telephony systems

(75) Inventors: Douglas Conklin, San Francisco, CA (US); Kevin McGowan, Monument, CO (US); Jeff Kemper, Concord, CA (US); Kalman Lau, San Francisco, CA (US)

Correspondence Address: HAYNES BEFFEL & WOLFELD LLP, P O BOX 366, HALF MOON BAY, CA, 94019, US

(73) Assignee: Clarus Systems, Inc., San Francisco, CA (US)

(21) Appl. No.: 11/372,601

(22) Filed: Mar. 10, 2006

Related U.S. Application Data
(60) Provisional application No. 60/660,326, filed on Mar. 11, 2005.

(51) Int. Cl. G06F 11/00

(52) U.S. Cl. 714/4

(57) ABSTRACT

A process of implementing a test plan for an IP-based telephony network. The process consists initially of installing a system test module as an integral component of the network-based system, whereby test procedures originate within the network-based system, employing system resources rather than outside components to accomplish testing. Further steps are assembling a set of generic functional tests, each test including the components of test elements, each element addressing a single system action, together with verification for completion of such action; test legs, each leg encompassing the actions of a single actor in the test and including interactions between such actors; and a test activity, setting out a single function to be accomplished by the test and combining the functions of one or more test legs, including the interactions among the same. Then the system proceeds by determining the network resources to be tested at a given time, including automatically determining the overall configuration of the network under test, to the extent possible; adding information required to complete the system configuration; building a system model of the network under test; integrating user input regarding system permissions and capabilities; user schedule considerations; and user test standards. Finally, the process concludes by executing the test plan, including the steps of allocating network resources required for test; balancing efficient testing considerations against resource constraints; determining availability of allocated resources; locking resources while in use; and iterating until all required resources have been tested.

### RELATED APPLICATIONS

This application is related to U.S. patent application Ser. No.______, entitled “Method and System for Generating a Generic Test Plan for Network Based Telephony Systems” filed 10 Mar. 2006 by Richard Whitehead, Kevin McGowan and David Roberts. That application is incorporated by reference.

This application claims the benefit of U.S. Provisional Patent Application No. 60/660,326, entitled “Dynamic Identification and Allocation of Resources and Encapsulation of Test Intent of an Automated Test System” filed on 11 March 2005 by Kevin McGowan, Eric Weise, Kamal Shah, Tony Mowers, Jeff Kemper, Kalman Lau, Douglas Conklin, Suleman Alam, Richard Whitehead and David Roberts. That application is incorporated by reference for all purposes.

### BACKGROUND OF THE INVENTION

The present invention relates to test systems. In particular, it relates to test systems and regimes for network-based telephony systems.

Testing private telephony systems generally amounts to placing a series of calls to determine the availability and quality of service. Telephone service providers have sophisticated systems for testing their overall networks, of course, but testing a system installed in an office building, for example, or with a multi-building campus is left to the purchaser.

The nature of network-based telephone systems makes the test problem more serious. This technology is often referred to as voice-over-internet-protocol (VoIP or Voice-over-IP), or as EP Telephony. Because the system is based on packet transmissions over whate4ver network path is optimal and available at a given moment, rather than establishing a dedicated, physical circuit, testing must be much more a part of everyday activity, and quality must be monitored more carefully than is the case for conventional systems.

A number of vendors have offered equipment to this area, primarily Agilent, Radcom and Mercury Interactive, yet no offering has appeared to present a complete solution to system installers and owners. Test regimes continue to rely on a test provider placing calls from outside the network to numbers within the network. That situation produces results that do not fully exercise the network, do not achieve economy of operation, and are not conducive to ongoing, routine test procedures.

The art thus continues to seek a system for providing a completely automated solution to the testing problem.

### SUMMARY OF THE INVENTION

An aspect of the invention is a process of implementing a test plan for an IP-based telephony network. The process consists initially of installing a system test module as an integral component of the network-based system, whereby test procedures originate within the network-based system, employing system resources rather than outside components to accomplish testing. Further steps are assembling a set of generic functional tests, each test including the components of test elements, each element addressing a single system action, together with verification for completion of such action; test legs, each leg encompassing the actions of a single actor in the test and including interactions between such actors; and a test activity, setting out a single function to be accomplished by the test and combining the functions of one or more test legs, including the interactions among the same. Then the system proceeds by determining the network resources to be tested at a given time, including automatically determining the overall configuration of the network under test, to the extent possible; adding information required to complete the system configuration; building a system model of the network under test; integrating user input regarding system permissions and capabilities; user schedule considerations; and user test standards. Finally, the process concludes by executing the test plan, including the steps of allocating network resources required for test; balancing efficient testing considerations against resource constraints; determining availability of allocated resources; locking resources while in use; and iterating until all required resources have been tested.

### BRIEF DESCRIPTION OF THE DRAWINGS

FIG. 1 illustrates a network-based telephony system as is known in the art.

FIG. 2 illustrates a network-based telephony system employing the test system of the present invention.

FIG. 3 depicts an embodiment of a test activity according to the present invention.

FIG. 4 illustrates another embodiment of a test activity according to the present invention.

FIG. 5 depicts the interaction of the test system and the user system to produce a test plan under the present invention.

FIG. 6 depicts an object model of a test plan, according to an embodiment of the present invention.

FIG. 7 illustrates an embodiment of the process for executing an embodiment of a test plan according to the present invention.

FIG. 8 illustrates an embodiment of the process for allocating, locking and employing resources in an embodiment of the present invention.

### DETAILED DESCRIPTION

The following detailed description is made with reference to the figures. Preferred embodiments are described to illustrate the present invention, not to limit its scope, which is defined by the claims. Those of ordinary skill in the art will recognize a variety of equivalent variations on the description that follows.

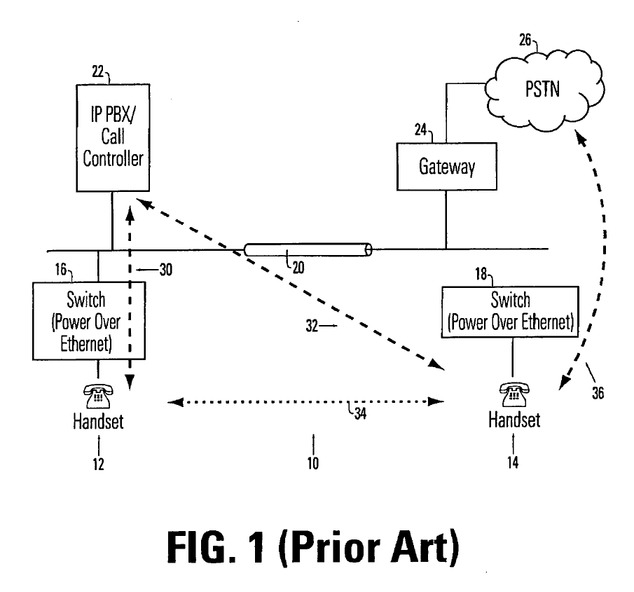

FIG. 1 illustrates a typical network-based telephony system. The term network-based, as known in the art, implies a telephony system that employs technology variously referred to as “IP telephony” or “voice over IP.” The fundamental difference between that technology and conventional telephony systems is that the latter features communication over a dedicated, physically established circuit. That is, a call is initiated by establishing a physical circuit between the parties, and that circuit remains so dedicated until the call is terminated. A network-based system, in contrast, follows the internet, or more accurately the internet protocol (IP) approach of breaking a communication into packets, each of which may follow a different communication path and are reassembled at the receiving end. The basic technology is well known and will not be described here in greater detail, but it should be understood that the cost advantages of a network-based approach are considerable.

In a typical network-based system 10, an individual handset 12 is connected to a network 20 via an interface switch 16. The network is preferably a conventional Ethernet or similar system. The switch accepts standard telephone handset connectors and is, from the user's perspective, identical to a connection to a conventional telephone system. Just as connections in a private closed system, such as an office building or company, are run through a private branch exchange (PBX), the local portion of a network-based system is controlled by an IP PBX 22. These devices are well-known in the art and are commercially available from suppliers such as Cisco Systems, Inc. and others. In a typical example, when the user of handset 12 wishes to place a call to the user of handset 14, the IP PBX signals each handset directly, via signals 30 and 32, with the result that an audio path 34 is created. Again, this explanation is presented by way of background and will not be elaborated here. It is preferred to employ a protocol such as the Real Time Protocol (RTP) in such a communication, but those in the art may implement a system in a number of ways.

Calls may be placed out of and into a network-based telephony system from the conventional telephone systems, usually referred to as the Public Switched Telephone Network (PSTN). Such calls pass through a gateway 24, which sets up an audio path 36. It bears repeating that the technology is completely transparent to the user, who is generally not aware of the nature of the system or its interface with the conventional network.

It can be easily appreciated that a network-based system will be much more difficult to test and implement that is a conventional system. A conventional system is readily set up and tested, because each connection is permanently wired. A network-based system must adapt to a network, which requires adaptation to the system involved and the particular network topology. In the conventional environment, quality is straightforwardly obtained, and once achieved is not likely to degrade. Just the opposite is true of a network-based system. Here, configuration is key, and quality must not only be achieved, but it also must be monitored continually.

Testing telephony systems is important from two aspects. First, the network must be certified for proper operation before commencing live operation. Often the certification requirements will be incorporated into the installation contract. Following the go-live point, testing must be performed continually, in order to ensure that quality and responsiveness characteristics are being met. Unlike a conventional system, a network-based system is much more vulnerable to external problems, principally involving the network. Also, the nature of the system present entire classes of potential problems, such as correct packet re-assembly, that are not present on conventional systems.

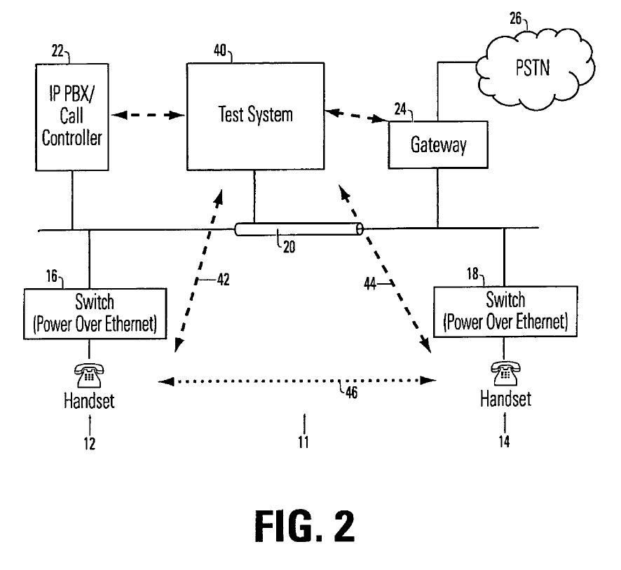

A network-based telephony system incorporating a test system based on the present invention is shown in FIG. 2. There, the test system 40 is interfaced directly to the network 20 as a component of the network itself. In operation, the test system takes control of the calling process, such as, for example, between handsets 12 and 14, via network signals 42 and 44, establishing audio path 46 between the calling devices. It is important to note that the test system 40 operates from within the network-based system, using network resources for the test process.

The operation of test system 40 is noteworthy from two aspects. First, as a component of the network based system, the test routine itself becomes a constituent part of normal network operation. Unlike the requirement of having an outside vendor periodically making calls into the network, testing here becomes an ongoing arm of quality control and monitoring. Second, the system utilizes the deployed infrastructure of the network-based system itself as the primary test resource, resulting in test procedures that are both quick to devise and install and thorough in execution.

Test system 40 executes a test plan for a particular network-based system. As noted above, each network-based system is different, requiring considerably more customization in developing a test plan than would be true for a conventional system.

It is understood by those in the art that test planning involves a number of preliminary considerations. Equipment selection and installation must precede system testing, of course, and it is presumed that a suitable call control system is installed and is operational within the bounds of the local network. Such systems are available-from a number of sources, but for purposes of explanation here, it will be assumed that the network employs the Cisco Call Manager (CCM) system.

Specifically, the following steps are all prerequisites to implementation of a system test plan. First, network topology must be laid out, with appropriate unit clusters defined. Then, the control system, such as CCM (one or more), must be installed, and connectivity to the defined clusters must be established and tested, including synchronization with whatever database and inventory resources that may be required. Finally, a system phonebook must be available, including whatever PSTN numbers are desired. At that point, with the network operational internally, a test plan can be devised and implemented.

A characteristic of prior art test regimes is their specificity—each test plan is completely unique to a particular customer site, which precludes the possibility of adapting a test plan from one location to another with ease or speed. Here, a salient advantage of the present invention is the fact that the building blocks for the tests are fully interchangeable. Thus, tests themselves are not one-piece mechanisms—here, tests are built from interchangeable components, making for easy upgrades of the base components, as well as ease in adapting tests to new circumstances, or building completely new tests.

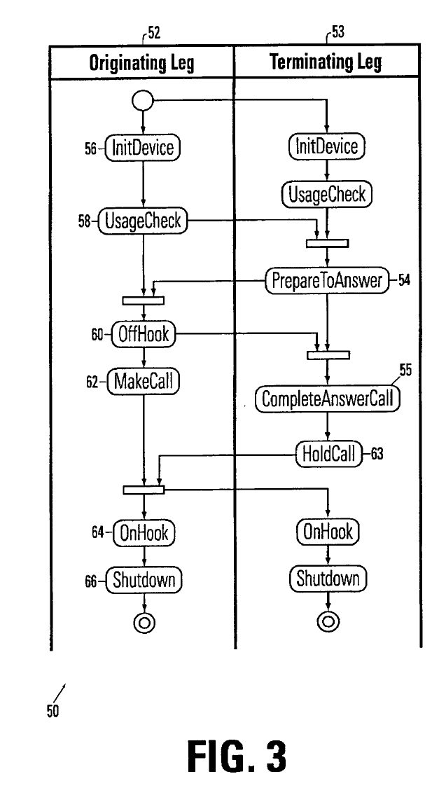

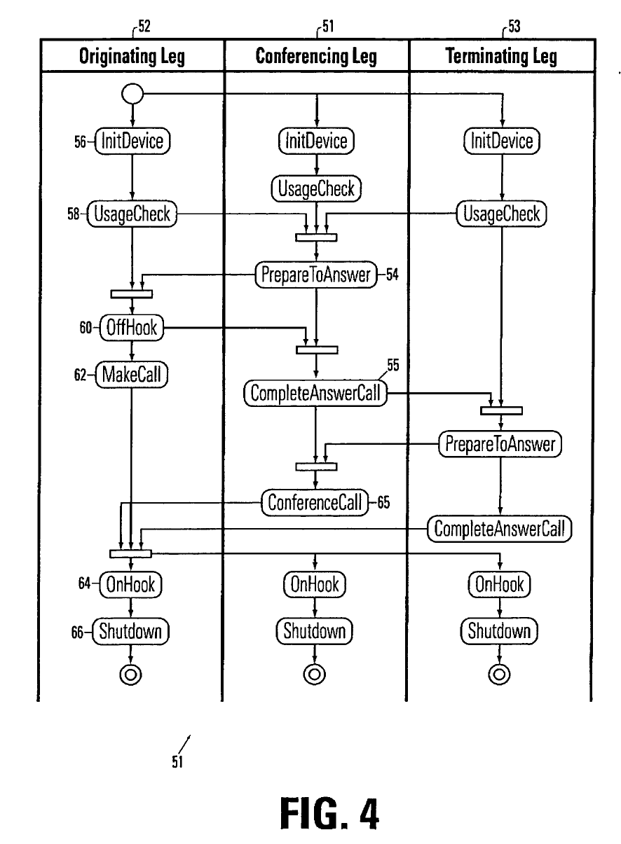

A test structure 50 is shown in FIG. 3. The test structure is highly organized, being composed of legs 52, 53, which in turn are composed of elements 54. Together, this structure provides a test function that completely operates to test a desired function of the network, which is termed an “activity.” Examples of activities include CallTransfer, which tests the function of transferring a call from one phone to another; ForwardToVoiceMail, which sets a phone to forward all incoming calls directly to voicemail, automatically; and Rollover, which sends calls automatically to another number. There is no limit to the number of such activities—as will be seen shortly, they can be structured however the user desires, and they can be as simple, or as complicated as the user desires. Illustrative examples of activities are shown in FIG. 3, the OnHold activity and FIG. 4 the Conference activity, each of which will be discussed in detail below.

As the names imply, the OnHold activity tests whether a given phone can accept an incoming call and place it on hold. The Conference activity tests whether a phone can initiate a call which is received by one other phone, and then a third phone is brought into the call. The CallForwardAll activity tests the function of forwarding all incoming calls to another line.

Activities themselves are subdivided into legs, so called because each leg involves one device, or actor, in the activity under test. In the OnHold activity, seen in FIG. ______, the actors are an originating leg 52 and a terminating leg 53. As can be seen on consideration, the actions required to put a call on hold involve two actors—a caller (who places the original call) and the receiver (who receives the call, answers the phone, and then places the call on hold). The actors here correspond exactly to the devices involved in these actions. Testing that activity requires the same two actors—an originating leg and a terminating leg.

The components of legs are termed “elements,” because they represent very fundamental, basic action steps. Elements are derived by splitting communications actions into ever-smaller units, until the point at which they cannot be further divided without losing meaning.

Thus, elements have the ability to perform a single, basic communications action, such as taking a device off-hook, putting it back on-hook, or placing a call. Moreover, each element further has the ability to verify the action taken. Thus, for example, element 56 not only initializes a device, but it also verifies that the initialization succeeded. Failure to initialize properly would result in an error generation, and the test would be aborted.

A brief look at the elements of FIG. 3 clarifies their operation. Both legs start with the InitDevice element 56 and UsageCheck element 58, ensuring that the two devices are operable and ready. The terminating leg then executes PrepareToAnswer 54, to which the originating leg responds with OffHook 60 and MakeCall 62. The terminating leg responds with CompleteAnswerCall 55 and HoldCall 63, after which both devices can execute OnHook 64 and Shutdown 66. Note that each separable action is executed and verified, followed by the next action and verification. At the end of the procedure, one can say with assurance that the phone on the terminating leg can receive a call and place it on hold.

The concepts set out above can be employed to build up actions of increasing complexity. FIG. 4, for example, sets out the Conference activity 51, which tests the ability of a single phone to conference other lines into a call. Here, originating leg 52 and terminating leg 53 are joined by conferencing leg 51. Like the OnHold activity, this activity begins with InitDevice and UsageCheck on each leg, followed by PrepareToAnswer 54 on the conferencing leg. The originating leg executes OffHook 60 and MakeCall 62, and the conferencing leg responds with CompleteAnswerCall 55. That brings the system to the point of being able to start the conferencing procedures, which the originating leg does with ConferenceCall 65, which loops the terminating leg into the call, as confirmed by the latter in by its CompleteAnswerCall, after which all legs can go on-hook and shut down.

Using the tools and concepts set out here, activities can be constructed covering every area of a network-based telephony system, enable the configuration of a complete test suite. In addition to the elements discussed above, some examples of other elements that might be needed include TransferCall, to move a call from one line to another; InitMeetMeConference, to initiate a meet-me conference feature at a selected conference number; or CheckRTP (Real Time Protocol). Those in the art can see from the list the discussion above the underlying principle and will be able to construct other elements, and thus other activities, as needed.

Having the tools to conduct testing, a detailed, site-specific test plan must be prepared. Here, the related application cited above, concerning a generic test plan, enables preparation of an overall approach, which here must be translated into a specific plan.

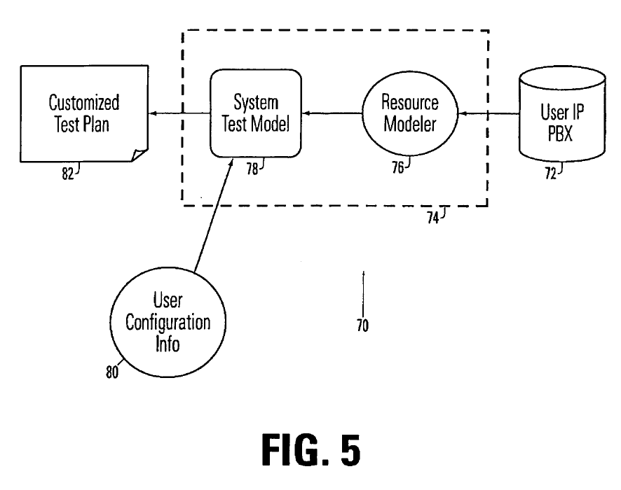

An embodiment of a process for combining a generic test plan with user information is shown in FIG. 5. There, the test system 74 is shown interfaced to the User IP PBX 72. The latter contains complete resource information about the user system, including the identification and location of all phones, together with any device pools or clusters defined. Within the test system, a resource modeling module 76 gathers that information to assemble a complete picture of the deployed infrastructure. That process is not simple copying, however, in that test considerations are integrated with the user system information. Thus, the process is not copying but modeling the user system.

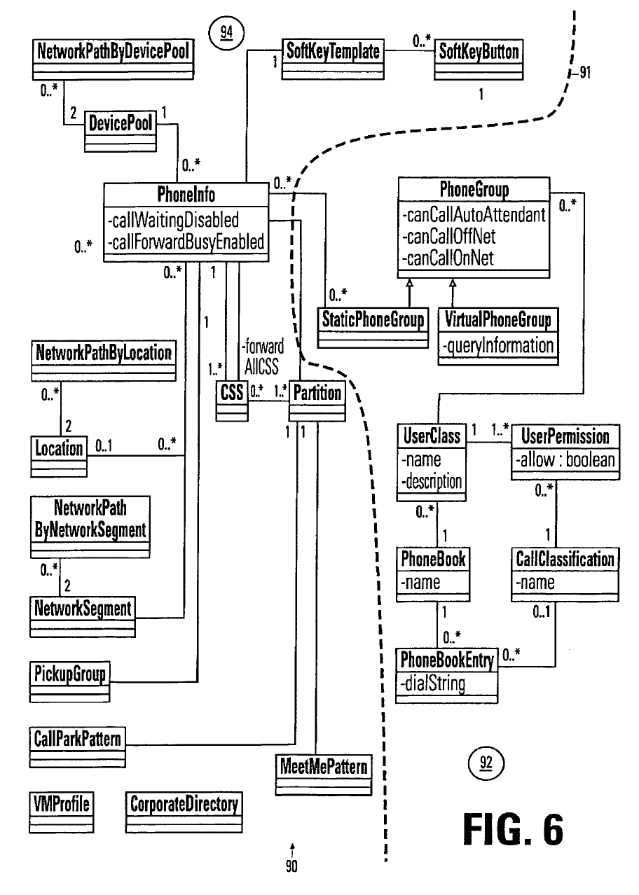

In addition to user physical data, the user also furnishes configuration information 80, which must be combined with the resource model to produce a final system test model 78 within the test system. This process, with its result, can be visualized from an example of a system test model 90 in FIG. 6. There, the model labeled PhoneInfo depicts a model of a user system, including its components. A number of such components represent physical entities of the deployed infrastructure, such as the PhoneGroup and it subsidiaries, and so on. These are shown to the right of line 91 in FIG. 6, and those items are portions of the deployed infrastructure that are gathered from the user EP PBX. Model items to the left of line 91 are configuration items. Such as network definitions, group definitions, the corporate directory, and so on. Those items are part of the User Configuration Information.

This interaction produces the customized test plan 82, which takes into account all of the user deployed infrastructure, the user configuration information, and system test planning. Among the specific tasks accomplished in system modeling are the following:
Resource allocation based on capabilities
Testing based on user-defined resource groups
Testing based on user-defined limitations—that is, specific instruments, such as lobby telephones, may be blocked from dialing outside the building, or other phones may be blocked from dialing long-distance PSTN numbers. Both the functionality and proper limitations must be tested.
Schedules must be adapted to user needs. A new system may be subjected to a rolling certification, for example, testing each night for the equipment added during the preceding day. An established system may have some portions monitored daily and subjected to more rigorous testing on downtimes, such as weekends.

The customized test plan, in short, contains a specific program for testing specific, assigned user equipment to specific tests, adapted from generic test plans and structured by the activities, and their subsidiary legs and elements. Test plans can be structured for new and existing facilities, for certification, monitoring, or ongoing quality control, as will be understood and implemented by those of skill in the art.

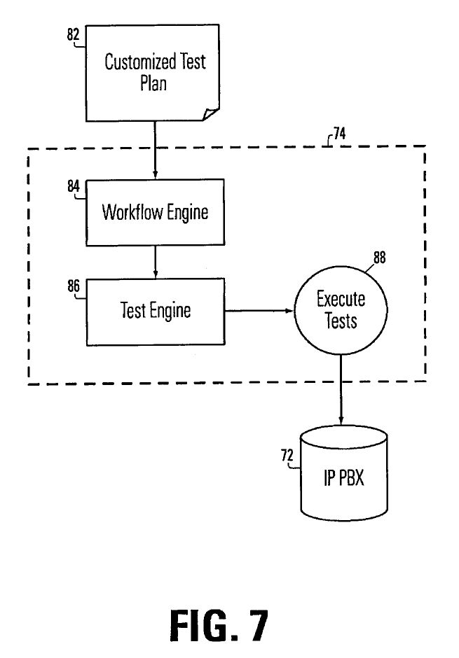

The process continues, as shown in FIG. 7, with the actual execution of the test plan. It should be understood that execution of a test plan can take a number of forms. In one example, a newly-installed network requires initial certification, which may be a single-step operation for a small system, or a multi-stage or rolling certification program for a large network. Another way to schedule the same situation might be a geographically dispersed certification program, where one office building or campus at a time is certified, until the entire network is covered. A different situation is presented by an upgrade or change to a portion of a network, and here consideration must be afforded to ongoing network operations as well as the certification task. A different scenario entirely is the ongoing quality assurance program, in which an ongoing, non-intrusive could be undertaken during operating hours, coupled with more extensive testing at nights or on weekends. The present invention easily lends itself to these and other situations.

As depicted in FIG. 7, the test system 74 accepts the customized plan 82, which is then processed in a workflow engine 84, which converts the test plan into a discrete series of actual tests performed on actual equipment, using techniques known to the art. A test engine 86 accepts the workflow and further reduces the plan to machine-level operations, which are then executed by an execution module 88 upon the IP PBX 72. The details of this portion of the test system are entirely conventional and can be implemented in a large number of different forms.

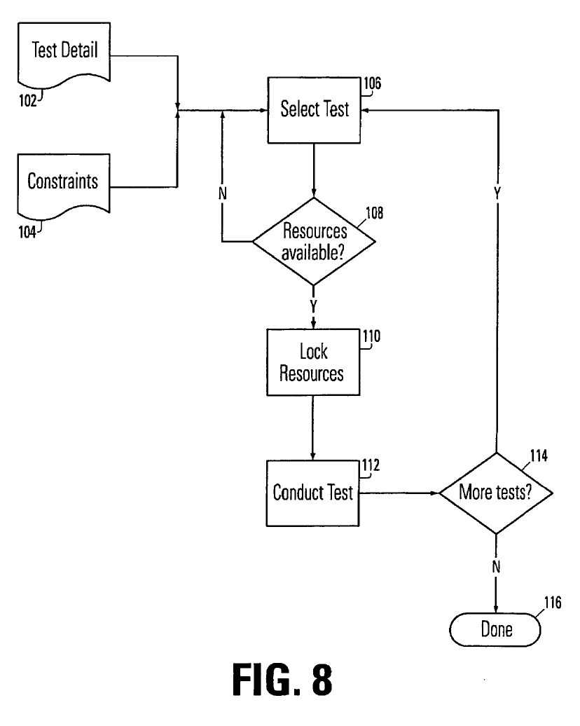

An important feature of the test execution, however, is shown in FIG. 8, and this portion of the process forms a key feature of the invention. An issue facing test scheduling everywhere is gaining access to the equipment or system to be tested. Prior art systems, requiring access to the network from outside, face particularly difficult problems, as the system must be turned over to the outside tester for the duration of testing. The fact that the present invention operates as part of the network-based system itself offers opportunities to alter that relationship.

As shown in FIG. 8, the test system first balances the requirements of the test detail plan 102 against constraints 104 to select a specific test, in step 106. The execution module then looks at the system to determine whether the resources required for that test (a particular group of phones, for example) are available, in step 108, and if they are, it places a lock on those resources in step 110. This ensures that no other use can be made of that resource during the duration of the test. As this all occurs under software control in real time, no single resource is taken out of service for extended periods in most test situations. If the resources for a particular test are not available, then the system loops back to locate another test, continuing until a test with available resources is identified. The test is then conducted, in step 112, and the system determines whether more tests are schedules, in step 114. If not, the system ends, in step 116.

What this series of operations provides is a test system that can be at once thorough and unobtrusive. Operating from inside the system, the test program can proceed continually, providing constant monitoring of system operation without requiring bothersome system shutdowns for testing.

While the present invention is disclosed by reference to the preferred embodiments and examples detailed above, it is understood that these examples are intended in an illustrative rather than in a limiting sense. Computer-assisted processing is implicated in the described embodiments. Accordingly, the present invention may be embodied in methods for building a generic system for testing network-based telephony systems; systems including logic and resources to carry out testing of network-based telephony systems; systems that take advantage of computer-assisted testing of network-based telephony systems; media impressed with logic to carry out testing of network-based telephony systems; data streams impressed with logic to carry out testing of network-based telephony systems; or computer-accessible services that carry out computer-assisted testing of network-based telephony systems. It is contemplated that modifications and combinations will readily occur to those skilled in the art, which modifications and combinations will be within the spirit of the invention and the scope of the following claims.

We claim as follows:

1. The process of implementing a test plan for an IP-based telephony network, comprising the steps of
installing a system test module as an integral component of the network-based system;
whereby test procedures originate within the network-based system, employing system resources rather than outside components to accomplish testing.

2. The process of implementing a test plan for an IP-based telephony network, comprising the steps of
installing a system test module as an integral component of the network-based system;
assembling a set of generic functional tests;
determining the network resources to be tested at a given time; and
executing the test plan.

3. The process of claim 2, wherein the installing step system resources rather than outside components to accomplish testing.

4. The process of claim 2, wherein the assembling step includes assembling a set of generic functional tests, each test including the following components:
test elements, each element addressing a single system action, together with verification for completion of such action;
test legs, each leg encompassing the actions of a single actor in the test and including interactions between such actors;
a test activity, setting out a single function to be accomplished by the test and combining the functions of one or more test legs, including the interactions among the same.

5. The process of claim 2, wherein determining the network resources to be tested at a given time includes the steps of:
automatically determining the-overall configuration of the network under test, to the extent possible;
adding information required to complete the system configuration;
building a system model of the network under test;
integrating user input regarding
system permissions and capabilities;
user schedule considerations;
user test standards.

6. The process of claim 2, wherein executing the test plan, includes the steps of allocating network resources required for test;
balancing efficient testing considerations against resource constraints;
determining availability of allocated resources;
locking resources while in use; and
iterating until all required resources have been tested.

7. A test plan for an IP-based telephony network, comprising:
a set of generic functional tests, each test including the following components:
test elements, each element addressing a single system action, together with verification for completion of such action;
test legs, each leg encompassing the actions of a single actor in the test and including interactions between such actors;
a test activity, setting out a single function to be accomplished by the test and combining the functions of one or more test legs, including the interactions among the same.

8. The process of implementing a test plan for an IP-based telephony network, comprising the steps of
installing a system test module as an integral component of the network-based system;
whereby test procedures originate within the network-based system, employing system resources rather than outside components to accomplish testing;
assembling a set of generic functional tests, each test including the following components:
test elements, each element addressing a single system action, together with verification for completion of such action;
test legs, each leg encompassing the actions of a single actor in the test and including interactions between such actors;
a test activity, setting out a single function to be accomplished by the test and combining the functions of one or more test legs, including the interactions among the same;
determining the network resources to be tested at a given time, including
automatically determining the overall configuration of the network under test, to the extent possible;
adding information required to complete the system configuration;
building a system model of the network under test;
integrating user input regarding
system permissions and capabilities;
user schedule considerations;
user test standards;
executing the test plan, including the steps of
allocating network resources required for test;
balancing efficient testing considerations against resource constraints;
determining availability of allocated resources;
locking resources while in use; and
iterating until all required resources have been tested.
